(19) United States
(12) Patent Application Publication
(10) Pub. No.: US 2011/0133454 A1
(43) Pub. Date: Jun. 9, 2011

(54) POWER GENERATION DEVICE

(76) Inventor: Hoang Luu Vo, Madison Heights, MI (US)

(21) Appl. No.: 12/630,010

(22) Filed: Dec. 3, 2009

(51) Int. Cl. F03D 9/00; H02P 9/04

(52) U.S. Cl. 290/44; 290/55

(57) ABSTRACT

A portable power generation device includes a housing, an articulated cover, and a first device including rotor blades for producing electrical energy when exposed to a flow of air, the first device is adapted to be articulated between a range from a first stored position, wherein the rotor blades of the first device are disposed within the housing, and a second deployed position, wherein the rotor blades of the first device are disposed outside of the housing. The power generation device also includes a second device for producing electrical energy when exposed to a source of radiant light.

### BACKGROUND OF THE INVENTION

The present invention relates to power generation devices, and more particularly to portable power generation devices and methods thereof.

Present generation electric vehicles are designed for shorter lengths of operation and are primarily for driving in a city environment or to commute short distances. The limits of travel on these vehicles are primarily due to the battery charge level of these vehicles not being sufficient for driving longer distances. The current state of battery technology has resulted in lengthy recharge times, shorter operational periods, and the lack of an established infrastructure for efficiently charging these vehicles while away from, for example, one's home.

One solution to this problem has been to combine electric systems with internal combustion engines thereby producing a hybrid vehicle which is capable of running on the electrical system, the combustion system, or a combination of both. With these systems, the driver is able to utilize the internal combustion engine and the existing infrastructure of gas stations to drive longer distances. However, any reduction in the environmental impact of these vehicles when operating under the power of the internal combustion engine is thereby negated.

Consequently, there is a need for power generation and/or charging systems that will increase the range of these electric vehicles while reducing the time required for recharge. Accordingly, a need exists for novel systems and methods which have, among other advantages, improvements directed to the recharging of rechargeable electrical (e.g., battery) systems. Therefore, a power generation device that solves the aforementioned disadvantages and having the aforementioned advantages is desired.

### SUMMARY OF THE PRESENT INVENTION

The aforementioned drawbacks and disadvantages of these former power generation devices have been identified and a solution is set forth herein by the inventive power generation device which includes a portable power generation device which comprises a housing, wherein the housing comprises a base, an articulated cover, and a rotatable support member. Also included is a first device comprising rotor blades for producing electrical energy when exposed to a flow of air, wherein the first device is adapted to be articulated between a range from a first stored position, wherein the rotor blades of the first device are disposed within the housing, and a second deployed position, wherein the rotor blades of the first device are disposed outside of the housing. The power generation device may also include a second device for producing electrical energy when exposed to a source of radiant light, wherein the second device is disposed on a surface of the housing which is adapted to receive radiant light.

Another aspect of the present invention includes a vehicle mountable power generation device which includes a housing disposed on a support structure. The support structure is adapted to removably affix to a vehicle surface and comprises a frame base and a rotatable support member, and the housing comprises a base and an articulated cover. The vehicle mountable power generation device also includes an adjustable opening disposed on one of the support structure or the housing for receiving wind therethrough when in an open position, and further comprises a first device including a first rotor blade assembly for converting the kinetic energy from the wind into mechanical energy, wherein the first device is adapted to be articulated between a range from a first position, wherein the first device is disposed within the housing, and a second position, wherein the first device is disposed outside of the housing. Further, the first rotor blade assembly includes at least one axially balanced airfoil, whereby the wind turbine is adapted to produce electrical energy when in the first position by receiving wind through the adjustable opening, and is adapted to produce electrical energy when in the second position by receiving wind outside of the housing, thereby producing electricity when in either the first or the second position. The vehicle mountable power generation device also includes a second device for producing electrical energy when exposed to a source of radiant light, wherein the second device is disposed on a surface of the housing which receives radiant light.

In another aspect of the present invention, a vehicle mountable power generation device comprises a housing disposed on a support structure, wherein the support structure is adapted to be removably affixed to a vehicle surface. The support structure includes a frame base and a rotatable support member, while the housing includes abase, and an articulated cover. The vehicle mountable power generation device also includes an adjustable opening disposed on one of the support structure or the housing for receiving wind therethrough when in an open position, and a wind turbine including a first and a second rotor blade assembly for converting the kinetic energy from the wind into mechanical energy, whereby the wind turbine is adapted to be articulated between a range from a first stored position, wherein the wind turbine is disposed within the housing, and a second deployed position, wherein the wind turbine is disposed outside of the housing. The first rotor blade assembly also includes at least two axially balanced airfoils, and the second rotor blade assembly includes leading and trailing ends defining respective leading and trailing openings, wherein the leading end is connected to the trailing end through a plurality of spaced blades. Further, the first rotor blade assembly is disposed within the second rotor blade assembly, such that a wing tip of each airfoil of the first rotor blade assembly is bounded by an inside surface of the second rotor blade assembly, whereby the inside surface of the second rotor blade assembly is defined by the inside surfaces of the leading and trailing ends, and the plurality of spaced blades. In this embodiment, the wind turbine is adapted to produce electrical energy: when in the first position by receiving wind through the adjustable opening; and when in the second position by receiving wind outside of the housing, thereby producing electricity when in either the first or second position. Further included: is a solar array for producing electrical energy when exposed to a source of radiant light, wherein the solar array is disposed on an outside surface of the housing receiving radiant light; and a power storage system for storing the converted solar and wind energy, whereby the power storage system is adapted to be disposed within the housing.

In another aspect of the present invention, a vehicle mountable power generation device comprises a housing disposed on a support structure. The support structure is adapted to removably affix to a vehicle surface and comprises a frame base, a rotatable support member, and an inlet support, the inlet support defining an opening. The housing includes a base and an articulated cover. Further, an adjustable opening is disposed on one of the support structure or the housing for receiving wind therethrough when in an open position. A wind turbine including a first and a second rotor blade assembly for converting the kinetic energy from the wind into electrical energy is also disclosed wherein the wind turbine is adapted to be articulated between a range from a first stored position, wherein the wind turbine is disposed within the housing, and a second deployed position, wherein the wind turbine is disposed outside of the housing. The first rotor blade assembly includes at least four axially balanced airfoils, and the second rotor blade assembly includes leading and trailing ends, defining respective leading and trailing openings, wherein the leading end is connected to the trailing end through a plurality of spaced blades. The first rotor blade assembly also comprises a chord length greater than a span of the airfoils and has trailing ends configured for clockwise rotation. The first rotor blade assembly is disposed within the second rotor blade assembly, whereby a wing tip of each airfoil of the first rotor blade assembly is bounded by an inside surface of the second rotor blade assembly, the inside surface of the second rotor blade assembly defined by the inside surfaces of the leading and trailing ends, and the plurality of spaced blades. Further, the leading opening of the second rotor blade assembly is larger than the trailing opening of the second rotor blade assembly, thereby forming a conically shaped first and second rotor blade assembly. Further, a first end of each blade connected to the leading end of the outer rotor blade assembly is radially offset from a second end of each blade connected to the trailing end of the outer rotor blade assembly, thereby forming a spiral blade configuration on the second blade assembly. The wind turbine is thereby adapted to produce electrical energy when in the first position by receiving wind through the adjustable opening, and when in the second position by receiving wind outside of the housing, thereby producing electricity when in either the first or second position. The device also includes a photovoltaic device for producing electrical energy when exposed to a source of radiant light, the photovoltaic device disposed on a surface of the housing receiving radiant light, and a power storage system for storing the converted solar and wind energy/power, whereby the power storage system is adapted to be disposed within the housing.

And still in another aspect of the present invention, a multi-directional wind turbine rotor blade assembly for converting the kinetic energy from the wind into mechanical electrical energy is disclosed and includes a multi-directional wind turbine rotor blade assembly comprising a first and a second rotor blade assembly wherein the first rotor blade assembly comprises at least one axially balanced airfoils, and the second rotor blade assembly comprises leading and trailing ends defining respective leading and trailing openings, wherein the leading end is connected to the trailing end through a plurality of spaced blades, whereby the first rotor blade assembly is disposed within the second rotor blade assembly and wherein a wing tip of each airfoil of the first rotor blade assembly is bounded by an inside surface of the second rotor blade assembly, the inside surface of the second rotor blade assembly defined by the inside surfaces of the leading and trailing ends and the plurality of spaced blades, such that the multi-directional wind turbine rotor blade assembly rotates when positioned in a first vertical position, and a second horizontal position, by receiving wind therethrough.

And yet still in another aspect of the present invention a method of charging a vehicle with a rechargeable power source comprises: providing a vehicle with a power generation device comprising a housing disposed on a support structure, wherein the support structure is adapted to removably affix to a vehicle surface, the support structure comprising a frame base, a rotatable support member, and an inlet support, the inlet support defining an opening; the housing comprising a base, and an articulated cover; a wind turbine including a first rotor blade assembly for converting the kinetic energy from the wind into electrical energy, the wind turbine adapted to be articulated between a range from a first stored position, wherein the wind turbine is disposed within the housing, and a second deployed position, wherein the wind turbine is disposed outside of the housing; and a photovoltaic device for producing electrical energy when exposed to a source of radiant light, the photovoltaic device disposed on a surface of the housing adapted to receive radiant light. The method further includes: providing a sensor adapted to measure a charge of a rechargeable power source of the vehicle; providing a proximity sensor adapted to determine if the wind turbine can be deployed to the second position without obstruction; providing a motion sensor adapted to measure vehicle movement; providing a charging circuit adapted to charge the rechargeable power source from at least one of the wind turbine and the photovoltaic device; detecting when the charge of the rechargeable power source is reduced by a predetermined amount, and if so; activating the charging circuit for the photovoltaic device thereby allowing the rechargeable power source to receive the charge from the photovoltaic device; determining if vehicle movement is below a predetermined threshold and if the wind turbine can be deployed to the second position without obstruction and if so, deploying the wind turbine to the second position and activating the charging circuit for the wind turbine thereby allowing the rechargeable power source to receive the charge generated from the wind turbine when in the second position; and detecting when the charge of the rechargeable power source exceeds a second predetermined amount, and if so deactivating one or more of the of the wind turbine charging circuit and the photovoltaic device charging circuit, so as to prevent an overcharge condition to the rechargeable power source.

Other objects, advantages, and features of the invention will become apparent upon consideration of the following detailed description and drawings. As such, the above brief descriptions set forth, rather broadly, the more important features of the present novel invention so that the detailed descriptions that follow may be better understood and so that the contributions to the art may be better appreciated. There are of course additional features that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. To wit, the power generation device of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims, unless so claimed.

Further, while the application of the inventive power generation device as disclosed herein will be discussed in relation to a vehicle mounted assembly, numerous other uses are envisioned and the systems disclosed herein can be utilized where any portable source of power is required.

As such, those skilled in the art will appreciate that the conception upon which this disclosure is based may readily be used as a basis for designing other structures, methods, and systems for carrying out the several purposes of the present invention. It is important therefore that the claims are regarded as including such equivalent constructions, as far as they do not depart from the spirit and scope of the present invention.

Further, the purpose of the Abstract is to enable the United States Patent and Trademark Office, the public generally, and especially the scientists, engineers, and practitioners in the art who are not familiar with patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any manner.

These and other objects, along with the various features and structures that characterize the invention, are pointed out with particularity in the claims annexed to and forming a part of this disclosure. For a better understanding of the power generation device of the present disclosure, its advantages, and the specific traits attained by its use, reference should be made to the accompanying drawings and other descriptive matter in which there are illustrated and described the preferred embodiments of the invention.

As such, while embodiments of the power generation device are herein illustrated and described, it is to be appreciated that various changes, rearrangements, and modifications may be made therein without departing from the scope of the invention as defined by the claims.

### BRIEF DESCRIPTION OF THE DRAWINGS

As a compliment to the description and for better understanding of the specification presented herein, 10 pages of drawings are disclosed with an informative, but not limiting, intention.

FIG. 1 is a perspective view of an embodiment of the power generation device of the present invention;

FIG. 2 is a perspective view of the power generation device of FIG. 1, with a first device in a first position;

FIG. 3 is a perspective view of the power generation device of FIG. 1, with the first device in a second position;

FIG. 4 is a side view of the power generation device of FIG. 1, affixed to a vehicle;

FIG. 5 is a side view of the power generation device of FIG. 1, being transported by a person;

FIG. 6 is a perspective view of another embodiment of the power generation device of the present invention, with the first device in the first position;

FIG. 7 is a perspective view of the power generation device of FIG. 6, with the first device in the second position;

FIG. 8 is a perspective view of the first device of FIG. 6;

FIG. 9 is a side perspective view of another embodiment of a first device;

FIG. 10 is a front view of the first device of FIG. 9;

FIG. 11 is a front perspective view of another embodiment of the power generation device, affixed to a vehicle;

FIG. 12 is side perspective view of another embodiment of the power generation device, affixed to a vehicle; and

FIG. 13 is a perspective view of the power generation device of FIG. 11, illustrating the rotation of an articulated cover.

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

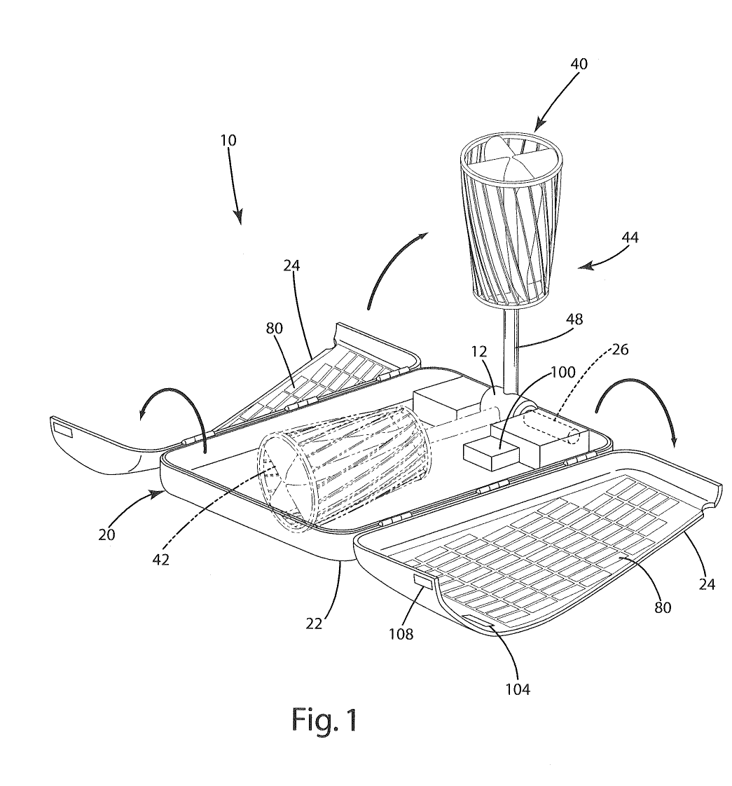

For purposes of description herein, the terms “upper”, “lower”, “right”, “left”, “rear”, “front”, “vertical”, “horizontal”, and derivatives thereof; shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

As used herein, the term vehicle is meant to be used and defined in its general and ordinary sense. To wit, a means of conveyance for carrying or transporting substances, objects, and people. For example, a car, truck, or the like. Of course, this is not meant to be limiting in any manner and these vehicles may take on numerous configurations, and may be used for numerous purposes as is generally known within the art.

As used herein, the term wind turbine is meant to be used and defined in its general and ordinary sense. To wit, a rotating machine which converts the kinetic energy in wind into mechanical energy. Of course, this is not meant to be limiting in any manner and these devices may take on numerous configurations, and may be used for numerous purposes as is generally known within the art.

As used herein, the term photovoltaic device is meant to be used and defined in its general and ordinary sense. To wit, a device that converts radiant energy into electricity. For example, a solar array. Of course, this is not meant to be limiting in any manner and these devices may take on numerous configurations, and may be used for numerous purposes as is generally known within the art.

As used herein, the term articulated is meant to be used and defined in its general, ordinary, yet broad sense. To wit, to allow movement; to be moved, opened, or closed; and regardless of a particular connection method. For example, the articulated cover as disclosed herein may be hingedly, rotatingly, or otherwise movably connected in any manner to the disclosed housing. As such, the method or device of articulation may take on numerous configurations.

In a broader and non-limiting sense, existing electric vehicles are primarily designed for short distance operation, wherein the limits of travel of these vehicles are primarily due to a battery charge capacity not being sufficient for driving longer distances. Further, existing battery technology has resulted in lengthy recharge times, short operational periods, and due to the lack of an established infrastructure for efficiently charging these vehicles, recharging these systems has become problematic.

One solution to this problem has been to combine electric systems with internal combustion engines thereby producing the hybrid vehicle which is capable of running on the electrical system, the combustion system, or a combination of both. With these hybrid systems, the driver is able to utilize the internal combustion engine and the existing infrastructure of gas stations to drive longer distances. However, any reduction in the environmental impact of these vehicles when operating under the power of the internal combustion engine is thereby negated.

Accordingly, a need exists for portable power generating devices and methods that allow for, inter alia, portability, ease of use, low cost, response to variable situations and environments, as well as increase the range of electric vehicles while reducing the time required to recharge such systems. Therefore, a portable power generating device that solves the aforementioned disadvantages and having the aforementioned advantages is disclosed herein.

The disadvantages and drawbacks of the prior art are overcome through the power generation device of the present invention, wherein one preferred embodiment is disclosed in FIGS. 1-5.

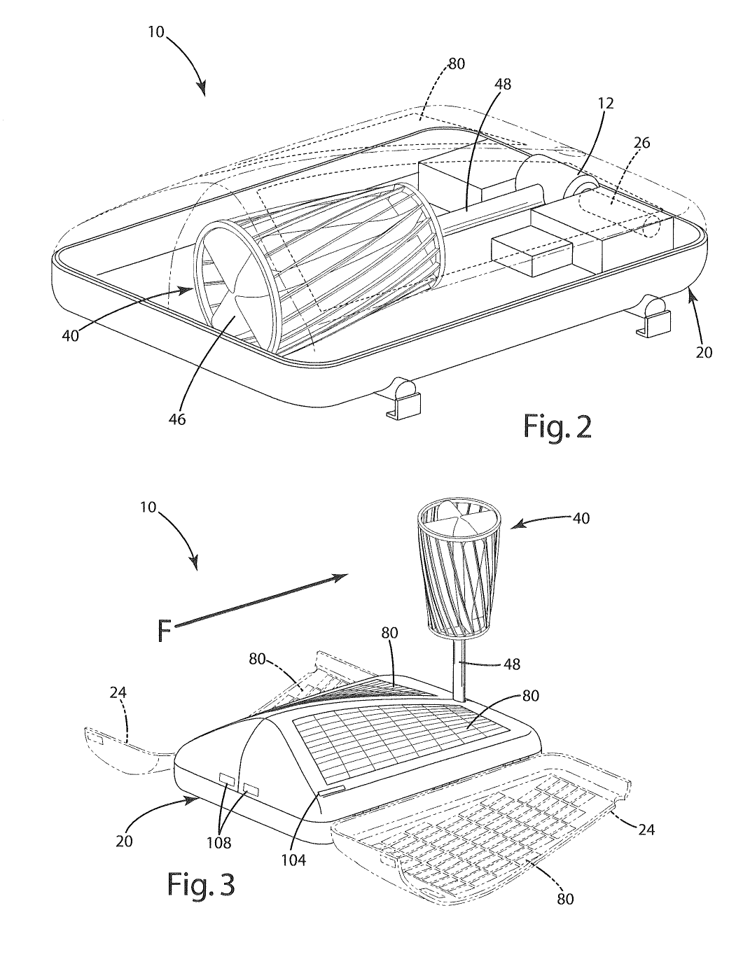

Referring now to FIG. 1, there is shown a portable power generation device 10 which comprises a housing 20, a first device 40, and a second device 80. The housing 20 includes a base 22, an articulated cover 24, and a rotatable support member 26. The first device 40 includes rotor blades 46 for producing electrical energy when exposed to a flow of air F, and first device 40 is adapted to be articulated, pivoted, or otherwise rotated between a range from a first stored position as illustrated in FIG. 2, wherein the rotor blades 46 of first device 40 are disposed within housing 20, and a second deployed position as illustrate in FIG. 3, wherein the rotor blades 46 are disposed outside of the housing 20. Power generation device 10 also includes a second device 80 for producing electrical energy when exposed to a source of radiant light, wherein the second device 80 is disposed on a surface of housing 20 which is capable of receiving radiant light.

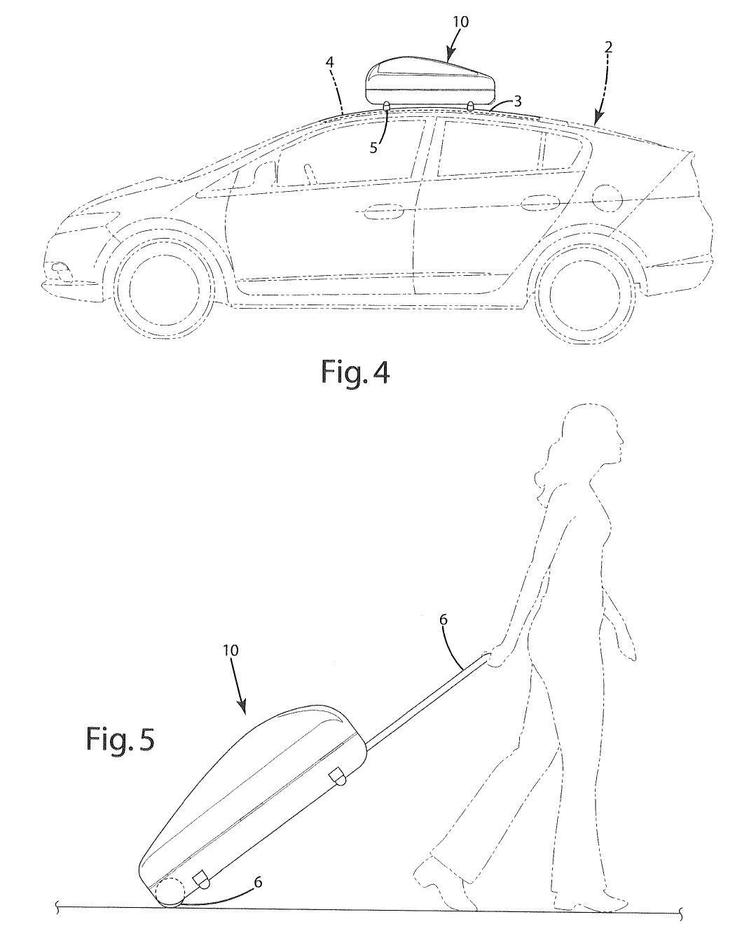

As illustrated by FIG. 1, housing 20 may comprise any suitable enclosure, cover, or the like which is adapted to retain first device 40 in a first stored position 42, and which allows for deployment of first device 40 to a second deployed position 44. Housing 20 may also comprise a base 22, wherein base 22 may comprise any of the numerous known devices which are adapted to suitably mount the housing to a surface of a vehicle 2. In one preferred embodiment (FIG. 4), housing 20 is adapted to be mounted to a cargo rack 3 disposed on a roof structure 4 of vehicle 2. This mounting configuration may comprise any known permanently mountable or removably mountable system, as the specific user requirements dictate. Housing 20 may further comprise one or more articulated covers 24. In one embodiment, housing 20 comprises two covers 24 which are hingedly attached to base 22 as illustrated, and are positionable from an open position as seen in FIG. 1, to a closed position as seen in FIG. 2. In a first embodiment, housing 20 also includes a rotatable support member 26 which is adapted to position first device 40 from the first position 42, to the second position 44, and the range therebetween. In this embodiment, first device 40 is operably connected to a generator 12 through a shaft 48. First device 40 and shaft 48 are connected or otherwise affixed so as to simultaneously rotate, wherein the rotational movement of shaft 48 (when in operation), drives generator 12, and whereby generator 12 produces, for example, electrical energy. In this embodiment, shaft 48 is connected with generator 12 so as to allow rotation therein. However, generator 12 is fixedly disposed on support member 26 such that generator 12 and support member 26 are fixedly positioned with respect to one another. That is to say: shaft 48 is connected to generator 12 for rotational movement therein; while generator 12 is affixed or otherwise fixedly disposed on support member 26 (i.e., in a non-rotational manner); while support member 26 is allowed to rotate within housing 20. In this manner, first device 40 may be moved from the first position 42, to the second position 44, as well as the range therebetween, and is able to convert energy in both the first and second positions, as well as the range therebetween as described further herein. Thus, first device 40 is adapted to produce electrical energy when positioned along a vertical axis, a horizontal axis, and a range therebetween.

Generator 12 may comprise any known device for converting the rotational movement of first device 40 into other forms of energy. In this embodiment, and for example only, generator 12 is operably connected to the rotor blades 46, through shaft 48. Of course, generator 12 may be positioned in other locations and connected to the first device 40 in any known manner.

As depicted in FIGS. 4-5, housing 20 may be operably affixed to a vehicle 2 (FIG. 4) through numerous known attachment devices 5 which are adapted to suitably mount the housing 20 to a surface of a vehicle 2 and further, housing 20 may comprise one or more conveyance systems and devices 6 (FIG. 5) for effectuating portability. For example, wheels and handles may be provided to assist with the transportation of generation device 10.

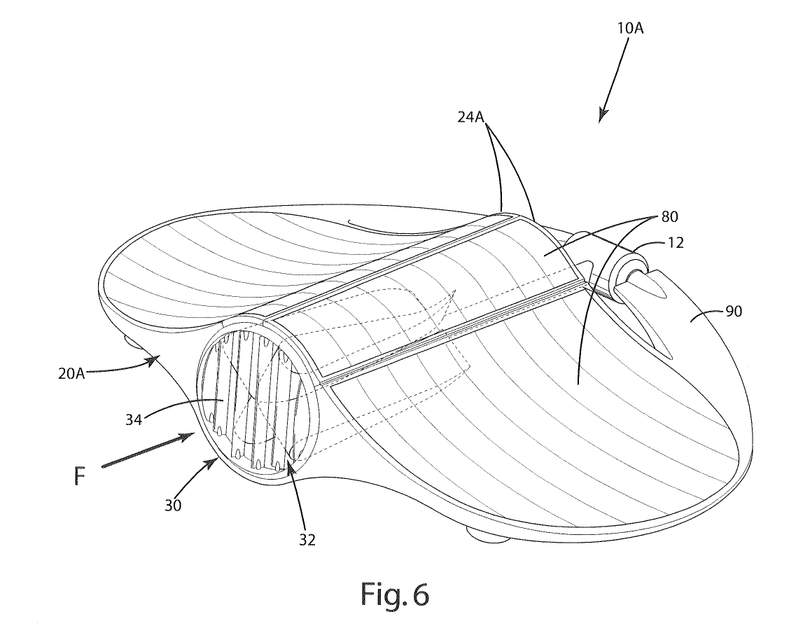

FIG. 6 illustrates another embodiment 10A, including a housing 20A which further includes an inlet 30. Inlet 30 defines an opening for receiving wind into housing 20A when in an open position. In this manner, and as described further herein, when in the first position 42, the first device 40 is adapted to rotate within housing 20A and thereby able to produce energy by receiving airflow F through inlet 30. When operational in this position, airflow F will enter housing 20A through inlet 30, thereby effectuating rotation of blades 46, and may exit housing 20A through cover 24A when in an open configuration, or through any other know manner (e.g., other openings) when articulated cover 24A is in a closed configuration. In the illustrated configuration, articulated cover 24A is adapted to open and close by rotating within housing 20A. In yet another embodiment, inlet 30 further comprises an adjustable opening 32 disposed therein for receiving wind therethrough. For example, adjustable opening 32 may comprise a louvered vent further comprising one or more positionable blades 34 which may be adjusted from a closed position, to a fully open position, and any range therebetween. This embodiment would further allow for control as to the amount of airflow F into housing 20A, thereby allowing control of the rate of spin of blades 46.

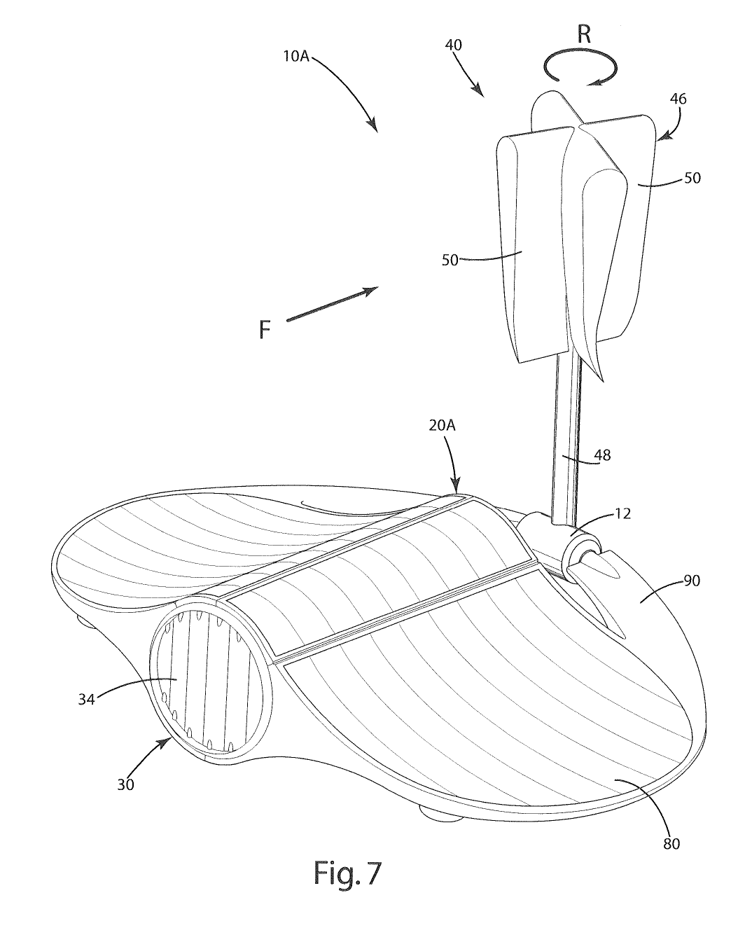

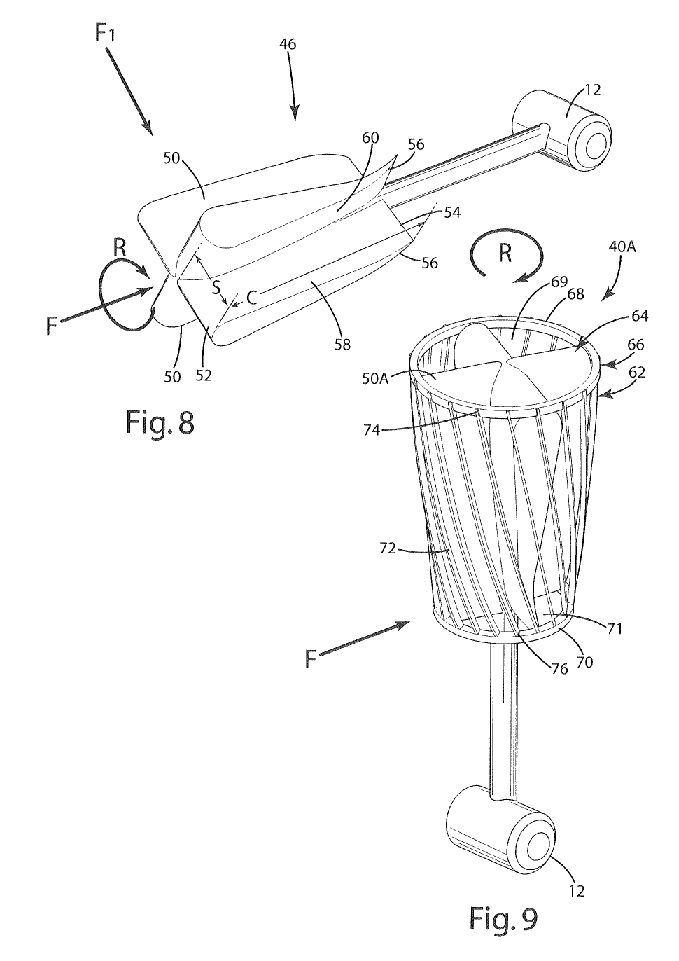

As illustrated by FIG. 7, first device 40 includes one or more rotor blades 46 for receiving airflow F, whereby airflow F causes rotation of rotating rotor blades 46 in order to produce energy. As described above, first device 40 is adapted to be articulated between a range from a first stored position 42, illustrated in FIG. 6, wherein the rotor blades 46 of first device 40 are disposed within housing 20A; and a second deployed position 44 as illustrated in FIG. 7, wherein the rotor blades 46 are disposed outside of the housing 20A. While first device 40 may comprise any device or machine which converts the kinetic energy of a moving stream of fluid (e.g., an airflow) into mechanical energy, in one preferred embodiment, first device 40 is a wind turbine with a rotational blade assembly.

Rotor blades 46 may comprise one or more rotor blades 46 which are axially balanced thereby allowing for rotational energy production. One embodiment further comprises at least two axially balanced airfoils 50 having a leading edge 52 and a trailing edge 54. Further, in one embodiment, airfoils 50 comprise a chord length C which is greater than a span S of the airfoils. Additionally, airfoils 50 may further comprise a trailing edge 54 configured to produce a clockwise rotation R of rotor blades 46. This may be accomplished, for example, by utilizing a turned edge 56 along trailing edge 54. In this configuration of airfoil 50, when subjected to airflow, a high pressure side 58 and a low pressure (suction) side 60 is maintained and a resultant clockwise rotation R is achieved. Further, utilizing these characteristics yields rotor blades 46 which are adapted to rotate when subjected to either an airflow F, a cross airflow F1, and a directional range of airflows therebetween. As such, rotor blades 46 are adapted to produce electrical energy when positioned along a vertical axis, a horizontal axis, and a range therebetween. In the illustrated embodiment, rotor blades 46 comprises at four axially balanced airfoils 50. However, any axially balanced configuration of one or more rotor blades 46 may also be used.

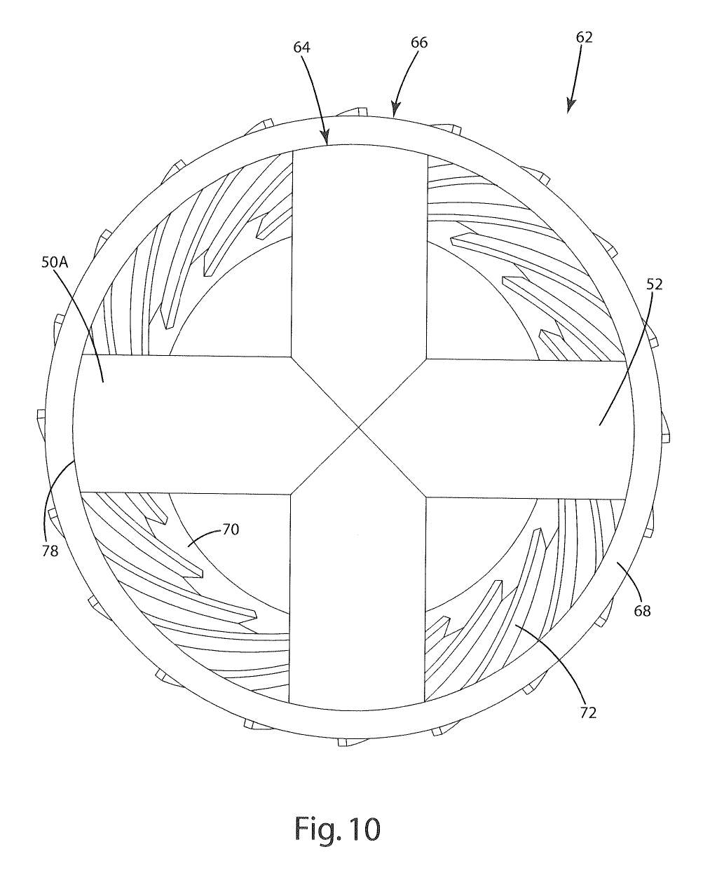

As illustrated in FIG. 9, an alternate embodiment of a wind turbine 40A is depicted wherein a multi-directional rotor blade assembly 62 comprises a first inner rotor blade assembly 64 and a second outer rotor blade assembly 66. As described above with respect to rotor blades 46, one embodiment of the inner rotor blade assembly 64 comprises one or more axially balanced airfoils 50A. In one embodiment, the outer rotor blade assembly 66 comprises a leading end 68 and a trailing end 70, defining respective leading 69 and trailing 71 openings. The leading end 68 is connected to the trailing end 70 through a plurality of spaced blades 72, whereby the inner rotor blade assembly 64 is disposed within the outer rotor blade assembly 66.

In the embodiment depicted in FIGS. 9-10, the inner rotor blade assembly 64 is bounded by the inside dimensions of outer rotor blade assembly 66 as defined by the inside dimensions of leading end 68, trailing end 70, and inside dimensions of the plurality of spaced blades 72. In this embodiment, a wing tip 78 of each airfoil 50A of first rotor blade assembly 64 is hounded by the inside surfaces of second rotor blade assembly 66: wherein the inside surface of second rotor blade assembly 66 is defined by the inside surfaces of the leading and trailing ends, 68 and 70, respectively, and the plurality of spaced blades 72. Further, the leading opening 69 of outer rotor blade assembly 66 is larger than the trailing opening 71, thereby forming a conically shaped rotor blade assembly 62. Additionally, a first end 74 of each blade 72 connected to leading end 68 of outer rotor blade assembly 66 is radially offset from a second end 76 connected to the trailing end 70, thereby forming a spiral blade configuration. Further yet, the airfoils 50A of inner rotor blade assembly 64 may comprise a chord length C greater than a span S of the respective airfoil. Although not meant to be limiting, this configuration of an inner and outer blade assembly, inter alia, improves the efficiency of assembly 62 when utilized as a vertical-axis wind turbine.

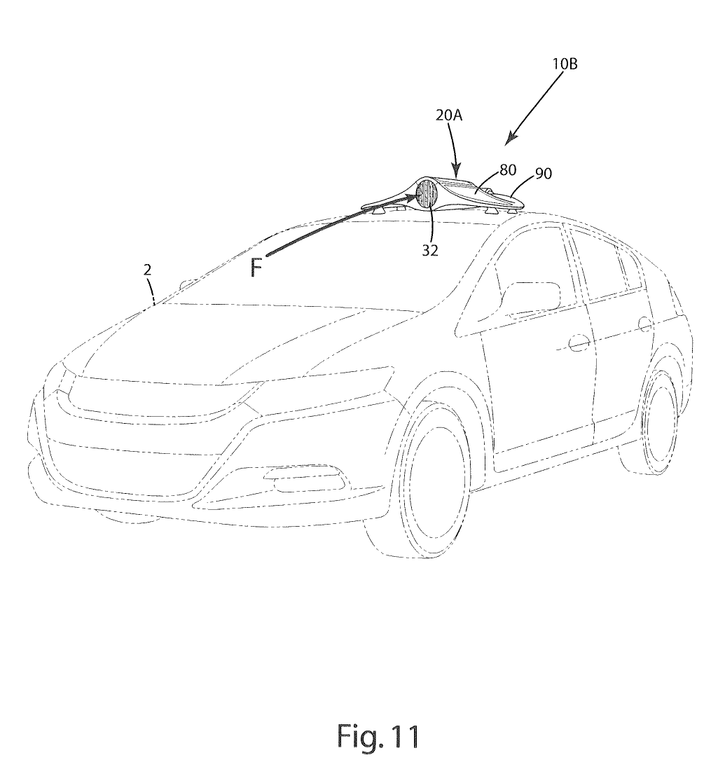

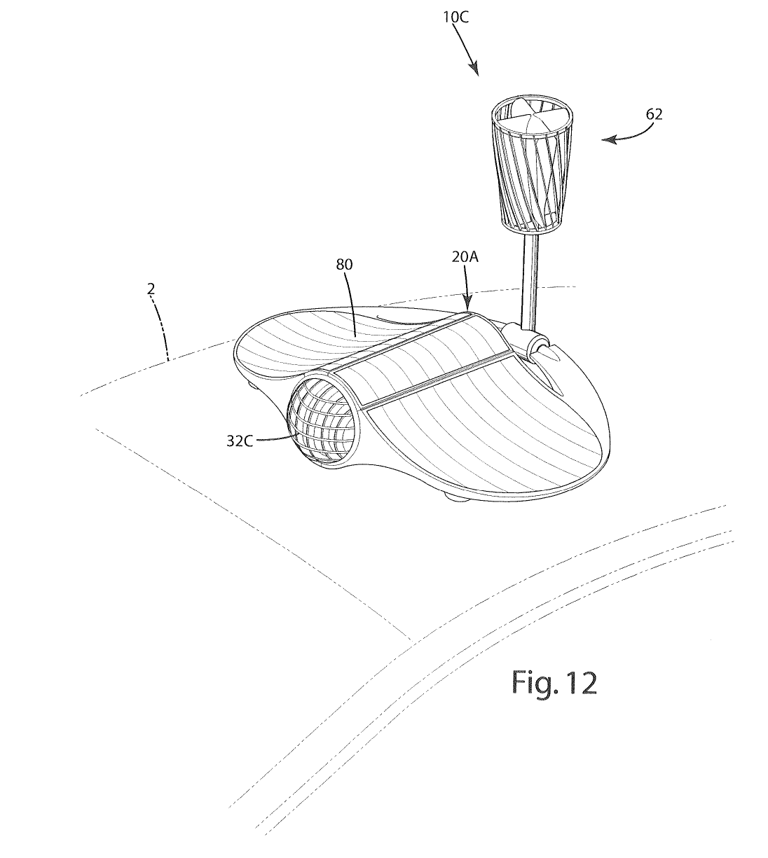

FIG. 11 illustrates an embodiment 10B which is adapted to be removably affixed to a vehicle 2, and supported by a support structure 90. As illustrated, rotor blade assembly 62 is shown in the first stored position 42, and the adjustable opening 32 is shown in an open position. This configuration allows the system 10B to operate and generate electricity when the vehicle is driven: the driven vehicle 2 providing an airflow F to blade assembly 62. FIG. 12 illustrates yet another embodiment 10C, wherein the adjustable opening 32 comprises a domed exterior surface for, inter alia, aerodynamic benefits. As illustrated, the rotor blade assembly 62 in shown in the second deployed position 44.

As best illustrated in FIGS. 1, 3, 6, 7 and 12, a second device 80 for producing electrical energy when exposed to a source of radiant light is disposed on housing 20, wherein second device 80 is disposed on a surface of housing 20 which is capable of receiving radiant light. In one embodiment, second device 80 comprises a plurality of photovoltaic devices creating a photovoltaic array. For example as illustrated in FIG. 3, solar panels may be disposed on a top surface of covers 24 in order to generate electricity when the covers are closed, as well as disposed on an inside surface of covers 24 in order to generate electricity when the covers are open.

As illustrated by FIG. 1, power generation device 10 may also include a power storage system 100 for storing the converted solar and wind energy/power, and in one embodiment is adapted to be disposed within housing 20. Any known power storage system may be utilized, for example, one or more batteries as is known in the art. Further, the housing 20 may also comprise one or more proximity sensors 104 for detecting when the wind turbine 40 may be deployed to the second deployed position 44 without encountering an obstruction. Any known sensor may be utilized as is known in the art. Still further yet, one or more motion sensors 108 for detecting movement (for example, movement of the vehicle) may also be utilized. This would prevent the wind turbine 40 from being moved to the deployed position 44 when motion sensor 108 senses movement of vehicle 2. Of course, this may also be determined through the vehicles existing speed measuring and sensing devices by providing a connection (e.g., communication) therebetween. Again, any known motion sensor may be utilized. Yet further, motion sensor 108 may also be adapted to retract wind turbine 40 to the stored position 42 when motion sensor 108 detects movement of the vehicle.

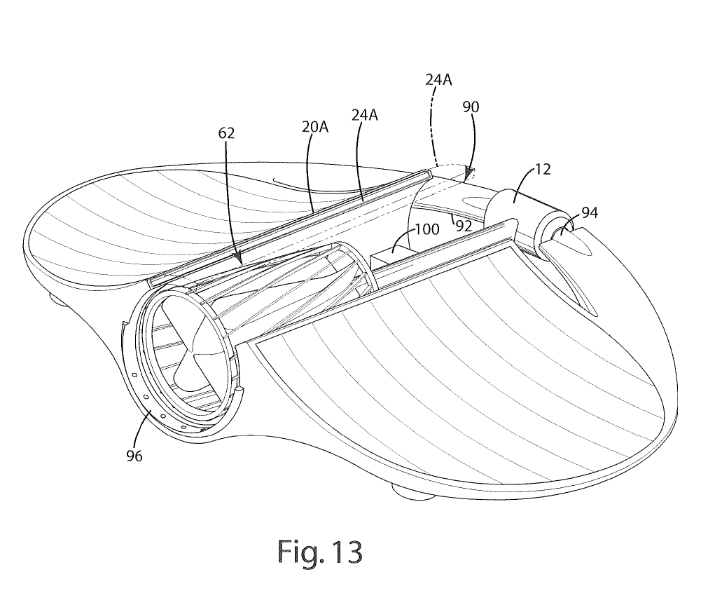

As illustrated by FIGS. 6, 7, 11, 12 and FIG. 13, housing 20 may be disposed on a support structure 90 for, inter alia, structural support. In this embodiment, support structure 90 comprises a frame base 92, a rotatable support member 94, and an inlet support 96, the inlet support defining an opening. Support structure 90, like housing 20 defined herein, may be mounted to the roof structure 4 of a vehicle 2, and further this mounting configuration may comprise any known permanently mountable or removably mountable system, as the specific user requirements dictate. Further, support structure 90 may also comprise devices to assist in the portability and transportation thereof as described hereinabove. Also illustrated by FIG. 13, housing 20A comprises one or more articulated covers 24A. In this embodiment, a pair of rotatable covers 24A are utilized and each cover 24A is articulated to rotate open and closed from within the housing 20A such that when in an open configuration (partially depicted by FIG. 13) the covers 24A are housed or otherwise stored within housing 20A. Covers 24A may be manually operated or automated in any known manner and by any known devices and systems. For clarification, FIG. 13 depicts one panel 24A in the closed position in hidden line on the left, and one panel in the open configuration on the right.

When used in conjunction with a vehicle 2, transportable power generation device 10 is able to generate electricity in most situations and at most times (e.g., day or night) due to the inclusion of a wind turbine 40, which may operate as a horizontal-axis turbine, a vertical-axis turbine, as well as at any range therebetween, and a solar panel 80 for collecting and converting radiant energy (e.g., sun light). In this manner, whether vehicle 2 is parked or moving, whether it is sunny, or windy, the device is capable of generating electricity and in particular, recharging the power source (for example only, the batteries) of an electric or hybrid vehicle. For example, when parked, system 10 may utilize one or more of the wind turbine 40 and the solar panels 80 to recharge the vehicles batteries or otherwise generate usable or stored power by converting ambient light and wind into electricity. In addition, when moving, system 10 may again utilize one or more of the wind turbine 40 and the solar panels 80 to recharge the vehicles batteries or otherwise generate usable or stored power, regardless of whether or not ambient light and/or wind are available. Further, system 10 may store the generated electricity through storage system 100, and may also be connected, either directly or indirectly, to a vehicles power system through known connections and devices. It is also possible for system 10 to automatically activate, either alone or in combination, the wind turbine 40 and the photovoltaic system 80, upon a specified threshold of battery charge. For example, known systems and methods can be employed to determine the charge level of the vehicles batteries and upon being discharged to a certain level, wherein the preferred discharge percentage may be based upon, for example, the manufacturer's recommendations, the system 10 can selectively activate one or both of systems 40 and 80 depending on, for example: whether the vehicle is moving and whether there are obstructions present to prevent deployment of turbine 40. To wit, if the system 10 detects movement, the system can activate the turbine 40 when in the stored position 42 by operating adjustable opening 32 (and adjusting the opening if desired), and/or the array 80. Alternatively, if system 10 detects no movement, the system may determine if the turbine 40 may be deployed to the second position 44 without obstruction and if so, deploy turbine 40, and/or activate the array 80. The system can then be deactivated (e.g., in reverse sequence) when the batteries are charged to a certain level, wherein the preferred charge percentage may be based upon, for example, the manufacturer's recommendations. Thus, portable power generation device 10 may be fully automated to deploy, activate, deactivate, and store according to the needs of the vehicle, whether or not the vehicle is moving, and whether or not ambient light and/or wind are available.

Also disclosed is a method of charging a vehicle with a rechargeable power source comprising the steps of: providing a vehicle with a power generation device 10 including a housing 20 disposed on a support structure 90, wherein support structure 90 is adapted to be removably affixed to a surface of a vehicle 2, wherein the support structure 90 further includes a frame base 92, a rotatable support member or arm 94, and an inlet support 96, whereby the inlet support defines an opening; and wherein housing 20 includes a base 22 and an articulated cover 24; further providing a wind turbine 40 including a first rotor blade assembly 64 for converting the kinetic energy from the wind into mechanical (e.g., electrical energy), the wind turbine 40 adapted to be articulated between a range from a first stored position 42, wherein the wind turbine 40 is disposed within housing 20, and a second deployed position 44, wherein the wind turbine 40 is disposed outside of the housing 20; and further providing a photovoltaic device 80 for producing electrical energy when exposed to a source of radiant light, the photovoltaic device disposed on a surface of the housing 20 which is adapted to receive radiant light; providing a sensor adapted to measure a charge of a rechargeable power source of the vehicle; providing a proximity sensor 104 adapted to determine if the wind turbine 40 can be deployed to the second position 44 without obstruction; providing a motion sensor 108 adapted to measure vehicle movement; providing a charging circuit adapted to charge the rechargeable power source from at least one of the wind turbine 40 and the photovoltaic device 80; detecting when the charge of the rechargeable power source is reduced by a predetermined amount, the predetermined amount being determined by manufacturer specifications (for example, when the charge is reduced by 70% of a fully charged rechargeable power source), and if so; activating the charging circuit for the photovoltaic device 80 thereby allowing the rechargeable power source to receive the charge from photovoltaic device; determining if vehicle movement is below a predetermined threshold and if the wind turbine 40 can be deployed to the second position 44 without obstruction and if so, deploying the wind turbine 40 to the second position 44 and activating the charging circuit for the wind turbine 40 thereby allowing the rechargeable power source to receive the charge generated from the wind turbine 40 when in the second position 44, otherwise, not deploying the wind turbine 40 to the second position 44 and not activating the charging circuit for the wind turbine 40; detecting when the charge of the rechargeable power source exceeds a second predetermined amount, the second predetermined amount being determined by manufacturer specifications (for example, when the charge is reduced by 10% of a fully charged rechargeable power source), and if so, deactivating one or more of the of the wind turbine charging circuit and the photovoltaic device charging circuit, so as to prevent an overcharge condition to the rechargeable power source.

The method of charging a vehicle with a rechargeable power source may further comprise the steps of: providing an adjustable opening 32 disposed on one of the support structure 90 or the housing 20 for receiving wind therethrough when in an open position; providing a wind turbine 40 including a first 64 and a second 66 rotor blade assembly for converting the kinetic energy from the wind into mechanical (e.g., electrical energy), the wind turbine 40 adapted to be articulated between a range from a first stored position 42, wherein the wind turbine is disposed within housing 20, and a second deployed position 44, wherein the wind turbine 40 is disposed outside of the housing 20; the first rotor blade assembly 64 comprising at least two axially balanced airfoils 50, and the second rotor blade assembly 66 comprising leading 68 and trailing 70 ends defining respective leading 69 and trailing 71 openings, the leading end 68 connected to the trailing end 70 through a plurality of spaced blades 72; the first rotor blade assembly 64 comprising a chord length C greater than a span S of the airfoils 50, and having trailing ends 54 configured for clockwise rotation R, wherein the first rotor blade assembly 64 is disposed within the second rotor blade assembly 66; wherein further a wing tip 78 of each airfoil 50 of the first rotor blade assembly 64 is bounded by an inside surface of the second rotor blade assembly 66, the inside surface of the second rotor blade assembly 66 defined by the inside surfaces of the leading 68 and trailing 70 ends, and the inside surfaces of the plurality of spaced blades 72; wherein yet further, the leading opening 69 of the second rotor blade assembly 66 is larger than the trailing opening 71 of the second rotor blade assembly 66, thereby forming a conically shaped first 64 and second 66 rotor blade assembly; wherein further a first end 74 of each blade 72 connected to the leading end 68 of the outer rotor blade assembly 66 is radially offset from a second end 76 of each blade 72 connected to the trailing end 70 of the second rotor blade assembly 66, thereby forming a spiral blade configuration on the second blade assembly 66; and determining if vehicle movement is below a (first) predetermined threshold, the predetermined threshold being determined by manufacturer specifications (for example, between a range of from 10.0 Miles-Per-Flour (MPH) to 0.0 MPH, more preferably from a range of from 5.0 MPH to 0.0 MPH, and most preferably 0.0 MPH), and if the wind turbine 40 can be deployed to the second position 44 without obstruction and if so, deploying the wind turbine 40 to the second position 44 and activating the charging circuit for the wind turbine 40 thereby allowing the rechargeable power source (of the system or of the vehicle) to receive the charge generated from the wind turbine 40 when in the second position 44; and if vehicle movement is not below the predetermined threshold, or alternatively is above a second predetermined threshold, the second predetermined threshold being determined by manufacturer specifications (for example, above 0.0 Miles-Per-Hour, more preferably above 1.0 MPH, and most preferably above 2.0 MPH), opening the adjustable opening 32 and activating the charging circuit for the wind turbine 40, thereby allowing the rechargeable power source to receive the charge generated from the wind turbine 40 when in the first position 42 and when vehicle movement is not at or below the first predetermined threshold, or alternatively is not at or above the second predetermined threshold.

The specific configurations and features of power generation device 10 may vary according to specific requirements. In one preferred embodiment, device 10 generally comprises a housing 20, a wind turbine 40, a photovoltaic device or array 80, and a support structure 90. This configuration may be fabricated from multiple components or in a one-piece configuration, and utilizes materials, systems, and fabrication techniques that are commonly known in the art. Further yet, it is envisioned that the style or configuration of housing 20, wind turbine 40, photovoltaic device or array 80, and support structure 90 can be varied and numerous other configurations can be fabricated. For example, the various surfaces may be configured in any geometry to suit the particular needs.

Further, the method of charging a vehicle with a rechargeable power source may accomplish one or more of the steps herein described, in varying order. As such, the method does not necessarily have a linear sequence of events. Therefore, while the method has been described by reference to the various steps performed therein, it is also to be understood that various modifications may be made to the method, it steps, and the like without departing from the inventive concept and that the description contained herein is merely a preferred embodiment and hence, not meant to be limiting unless stated otherwise.

Advantageously, the portable power generating devices and methods disclosed herein allow for, inter alia, portability, ease of use, low cost, responsiveness to variable situations and environments, and increase the range of electric vehicles while reducing the time required to recharge such systems.

The solutions offered by the invention disclosed herein have thus been attained in an economical, practical, and facile manner. To wit, a novel portable power generating device which is cost effective, portable, easily installed and removed, strong, responds to variable situations and environments, and increases the range of electric vehicles while reducing the time required to recharge such systems has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to be appreciated that various changes, rearrangements, and modifications may be made therein, without departing from the scope of the invention as defined by the claims.

The invention claimed is:

1. A portable power generation device comprising:
a housing, the housing comprising a base, an articulated cover, and a rotatable support member;
a first device including rotor blades for producing electrical energy when exposed to a flow of air, the first device adapted to be articulated between a range from a first stored position, wherein the rotor blades of the first device are disposed within the housing, and a second deployed position, wherein the rotor blades of the first device are disposed outside of the housing; and
a second device for producing electrical energy when exposed to a source of radiant light, the second device disposed on a surface of the housing adapted to receive radiant light.

2. The power generation device according to claim 1 wherein:
the rotor blades comprise at least one axially balanced airfoil, the airfoils having a chord length greater than a span of the airfoils whereby the first device is adapted to produce electrical energy when positioned along a vertical axis, a horizontal axis, and a range therebetween.

3. The power generation device according to claim 1 wherein:
the rotor blades comprise an inner rotor blade assembly and an outer rotor blade assembly;
the inner rotor blade assembly comprising at least two axially balanced airfoils;
the outer rotor blade assembly comprising leading and trailing ends, defining respective leading and trailing openings, the leading end connected to the trailing end through a plurality of spaced blades;
the inner rotor blade assembly disposed within the outer rotor blade assembly;
whereby the first device is adapted to produce electrical energy when positioned along a vertical axis, a horizontal axis, and a range therebetween.

4. The power generation device according to claim 3 wherein:
the airfoils of the inner rotor blade assembly comprise a chord length greater than a span of the airfoils.

5. The power generation device according to claim 3 wherein:
the leading opening of the outer rotor blade assembly is larger than the trailing opening of the outer rotor blade assembly forming a conically shaped outer and inner rotor blade assembly.

6. The power generation device according to claim 5 wherein:
a first end of each blade connected to the leading end of the outer rotor blade assembly is radially offset from a second end of each blade connected to the trailing end of the outer rotor blade assembly, thereby forming a spiral blade configuration.

7. The power generation device according to claim 3 wherein:
the housing further comprises an inlet defining an opening for receiving wind therethrough;
wherein further when in the first position, the first device produces electrical energy by receiving airflow through the opening.

8. The power generation device according to claim 7 wherein:
the inlet further comprises an adjustable opening disposed therein for receiving wind therethrough when in an open position.

9. The power generation device according to claim 3 wherein:
the housing is adapted to be removably mountable to a surface of a vehicle.

10. The power generation device according to claim 3 further comprising:
a power storage system for storing the converted solar and wind energy, the power storage system adapted to be disposed within the housing.

11. The power generation device according to claim 3 further comprising:
a proximity sensor adapted to determine if the first device is able to be articulated to the deployed position without obstruction.

12. The power generation device according to claim 3 further comprising:
a vehicle motion sensor for detecting movement of a vehicle and preventing the first device from being moved to the deployed position when the vehicle motion sensor senses movement of the vehicle.

13. The power generation device according to claim 12 wherein:
the motion sensor is further adapted to retract the first device to the stored position when the motion sensor detects movement of the vehicle.

14. A vehicle mountable power generation device comprising:
a housing disposed on a support structure;
the support structure adapted to removably affix to a vehicle surface, the support structure comprising a frame base, and a rotatable support member;
the housing comprising a base, and an articulated cover;
an adjustable opening disposed on one of the support structure or the housing for receiving wind therethrough when in an open position;
a first device including a first rotor blade assembly for converting the kinetic energy from the wind into mechanical energy, the first device adapted to be articulated between a range from a first position, wherein the first device is disposed within the housing, and a second position, wherein the first device is disposed outside of the housing;
the first rotor blade assembly comprising at one axially balanced airfoil, whereby the first device is adapted to produce electrical energy when in the first position by receiving wind through the adjustable opening, and adapted to produce electrical energy when in the second position by receiving wind outside of the housing, thereby producing electricity when in either the first or the second position; and
a second device for producing electrical energy when exposed to a source of radiant light, the second device disposed on a surface of the housing receiving radiant light.

15. The vehicle mountable power generation device according to claim 14 wherein:
the first device further comprises a second rotor blade assembly;
the second rotor blade assembly comprising leading and trailing ends defining respective leading and trailing openings, the leading end connected to the trailing end through a plurality of spaced blades;
the first rotor blade assembly disposed within the second rotor blade assembly, whereby a wing tip of each airfoil of the first rotor blade assembly is bounded by an inside surface of the second rotor blade assembly, the inside surface of the second rotor blade assembly defined by the inside surfaces of the leading and trailing ends and the plurality of spaced blades.

16. The vehicle mountable power generation device according to claim 15 wherein:
the airfoils of the first rotor blade assembly comprise a chord length greater than a span of the airfoils.

17. The vehicle mountable power generation device according to claim 15 wherein:
the leading opening of the second rotor blade assembly comprises an area larger than the area of the trailing opening of the second rotor blade assembly, thereby forming a conically shaped first rotor blade assembly.

18. The vehicle mountable power generation device according to claim 17 wherein:
a first end of each blade connected to the leading end of the outer rotor blade assembly is radially offset from a second end of each blade connected to the trailing end of the outer rotor blade assembly, thereby forming a spiral blade configuration on the second blade assembly.

19. The vehicle mountable power generation device according to claim 14 wherein:
the adjustable opening comprises a louvered vent.

20. The vehicle mountable power generation device according to claim 14 further comprising:
a power storage system for storing the converted solar and wind energy, the power storage system adapted to be disposed within the housing.

21. The vehicle mountable power generation device according to claim 14 further comprising:
a proximity sensor adapted to determine if the first device is able to be articulated to the second position without obstruction.

22. The vehicle mountable power generation device according to claim 14 further comprising:
a vehicle motion sensor for detecting movement of the vehicle and preventing the first device from being moved to the second position when the vehicle motion sensor senses movement of the vehicle.

23. The vehicle mountable power generation device according to claim 22 wherein:
the motion sensor is adapted to retract the first device to the first position when the motion sensor detects movement of the vehicle.

24. A vehicle mountable power generation device comprising:
a housing disposed on a support structure;
the support structure adapted to be removably affixed to a vehicle surface, the support structure comprising a frame base, and a rotatable support member;
the housing comprising abuse, and an articulated cover;
an adjustable opening disposed on one of the support structure or the housing for receiving wind therethrough when in an open position;
a wind turbine including a first and a second rotor blade assembly for converting the kinetic energy from the wind into mechanical energy, the wind turbine adapted to be articulated between a range from a first stored position, wherein the wind turbine is disposed within the housing, and a second deployed position, wherein the wind turbine is disposed outside of the housing;
the first rotor blade assembly comprising at least two axially balanced airfoils, the second rotor blade assembly comprising leading and trailing ends, defining respective leading and trailing openings, the leading end connected to the trailing end through a plurality of spaced blades;
the first rotor blade assembly disposed within the second rotor blade assembly, whereby a wing tip of each airfoil of the first rotor blade assembly is bounded by an inside surface of the second rotor blade assembly, the inside surface of the second rotor blade assembly defined by inside surfaces of the leading and trailing ends and inside surfaces of the plurality of spaced blades;
whereby the wind turbine is adapted to produce electrical energy, when in the first position by receiving wind through the adjustable opening, and when in the second position by receiving wind outside of the housing, thereby producing electricity when in one of the first or second position;
a solar array for producing electrical energy when exposed to a source of radiant light, the solar array disposed on an outside surface of the housing receiving radiant light; and
a power storage system for storing the converted solar and wind energy, the power storage system adapted to be disposed within the housing.

25. The vehicle mountable power generation device according to claim 24 wherein:
the airfoils of the first rotor blade assembly comprise a chord length greater than a span of the airfoils.

26. The vehicle mountable power generation device according to claim 24 wherein:
the leading opening of the second rotor blade assembly comprises a diameter larger than the diameter of the trailing opening of the second rotor blade assembly, thereby forming a conically shaped first and second rotor blade assembly.

27. The vehicle mountable power generation device according to claim 26 wherein:
a first end of each blade connected to the leading end of the outer rotor blade assembly is radially offset from a second end of each blade connected to the trailing end of the outer rotor blade assembly, thereby forming a spiral blade configuration on the second blade assembly.

28. A vehicle mountable power generation device comprising:
a housing disposed on a support;
the support adapted to removably affix to a vehicle surface, the support comprising a frame, a rotatable support member, and an inlet support, the inlet support defining an opening;
the housing comprising abase and an articulated cover;
an adjustable opening disposed on one of the support structure or the housing for receiving wind therethrough when in an open position;
a wind turbine including a first and a second rotor blade assembly for converting the kinetic energy from the wind into electrical energy, the wind turbine adapted to be articulated between a range from a first stored position, wherein the wind turbine is disposed within the housing, and a second deployed position, wherein the wind turbine is disposed outside of the housing;
the first rotor blade assembly comprising at least four axially balanced airfoils, the second rotor blade assembly comprising leading and trailing ends, defining respective leading and trailing openings, the leading end connected to the trailing end through a plurality of spaced blades;
the first rotor blade assembly comprises a chord length greater than a span of the airfoils, having trailing ends configured for clockwise rotation, the first rotor blade assembly disposed within the second rotor blade assembly;
wherein a wing tip of each airfoil of the first rotor blade assembly is bounded by an inside surface of the second rotor blade assembly, the inside surface of the second rotor blade assembly defined by inside surfaces of the leading and trailing ends and inside surfaces of the plurality of spaced blades;
wherein further a diameter of the leading opening of the second rotor blade assembly is larger than a diameter of the trailing opening of the second rotor blade assembly, thereby forming a conically shaped first and second rotor blade assembly, and a first end of each blade connected to the leading end of the outer rotor blade assembly is radially offset from a second end of each blade connected to the trailing end of the outer rotor blade assembly, thereby forming a spiral blade configuration on the second blade assembly;
the wind turbine adapted to produce electrical energy, when in the first position by receiving wind through the adjustable opening, and when in the second position by receiving wind outside of the housing, thereby producing electricity when in either the first and second position;
a photovoltaic device for producing electrical energy when exposed to a source of radiant light, the photovoltaic device disposed on a surface of the housing receiving radiant light; and
a power storage system for storing the converted solar and wind energy, the power storage system adapted to be disposed within the housing.

29. A multi-directional wind turbine rotor blade assembly for converting the kinetic energy from the wind into mechanical energy comprising:
a multi-directional wind turbine rotor blade assembly comprising a first and a second rotor blade assembly;
the first rotor blade assembly comprising at least one axially balanced airfoil, the second rotor blade assembly comprising leading and trailing ends, defining respective leading and trailing openings, the leading end connected to the trailing end through a plurality of spaced blades;
the first rotor blade assembly disposed within the second rotor blade assembly;
wherein a wing tip of each airfoil of the first rotor blade assembly is bounded by an inside surface of the second rotor blade assembly, the inside surface of the second rotor blade assembly defined by the inside surfaces of the leading and trailing ends and the plurality of spaced blades;
whereby the multi-directional wind turbine rotor blade assembly rotates when positioned in a first vertical position, and a second horizontal position, by receiving wind therethrough.

30. The wind turbine rotor blade assembly according to claim 29 wherein:
the airfoils of the first rotor blade assembly comprise trailing edges configured for clockwise rotation.

31. The wind turbine rotor blade assembly according to claim 29 wherein:
the airfoils of the first rotor blade assembly comprise a chord length greater than a span of the airfoils.

32. The wind turbine rotor blade assembly according to claim 29 wherein:
an area of the leading opening of the second rotor blade assembly is larger than an area of the trailing opening of the second rotor blade assembly, thereby forming a conically shaped first and second rotor blade assembly.

33. The wind turbine rotor blade assembly according to claim 32 wherein:
a first end of each blade connected to the leading end of the outer rotor blade assembly is offset from a second end of each blade connected to the trailing end of the outer rotor blade assembly, thereby forming a spiral blade configuration on the second blade assembly.

34. A method of charging a vehicle with a rechargeable power source comprising:
providing a vehicle with a power generation device comprising:
a housing disposed on a support structure;
the support structure adapted to removably affix to a vehicle surface, the support structure comprising a frame base, a rotatable support member, and an inlet support, the inlet support defining an opening;
the housing comprising a base, and an articulated cover;
a wind turbine including a first rotor blade assembly for converting the kinetic energy from the wind into electrical energy, the wind turbine adapted to be articulated between a range from a first stored position, wherein the wind turbine is disposed within the housing, and a second deployed position, wherein the wind turbine is disposed outside of the housing; and
a photovoltaic device for producing electrical energy when exposed to a source of radiant light, the photovoltaic device disposed on a surface of the housing adapted to receive radiant light;
providing a charge sensor adapted to measure a charge of a rechargeable power source of the vehicle;
providing a proximity sensor adapted to determine if the wind turbine can be deployed to the second position without obstruction;
providing a motion sensor adapted to measure vehicle movement;
providing a charging circuit adapted to charge the rechargeable power source from at least one of the wind turbine and the photovoltaic device;
detecting when a charge of the rechargeable power source is reduced by a predetermined amount, and if so;
activating the charging circuit for the photovoltaic device thereby allowing the rechargeable power source to receive the charge from the photovoltaic device;
determining if vehicle movement is below a predetermined threshold and if the wind turbine can be deployed to the second position without obstruction and if so, deploying the wind turbine to the second position and activating the charging circuit for the wind turbine thereby allowing the rechargeable power source to receive the charge generated from the wind turbine when in the second position;
detecting when the charge of the rechargeable power source exceeds a second predetermined amount, and if so deactivating one or more of the of the wind turbine charging circuit and the photovoltaic device charging circuit, so as to prevent an overcharge condition to the rechargeable power source.

35. The method of charging a vehicle according to claim 34 wherein:
the providing step further includes providing an adjustable opening disposed on one of the support structure or the housing for receiving wind therethrough when in an open position; and
the determining step further comprises, and if vehicle movement is not below the predetermined threshold, opening the adjustable opening and activating the charging circuit for the wind turbine, thereby allowing the rechargeable power source to receive the charge generated from the wind turbine when in the first position and when vehicle movement is not below the predetermined threshold.

36. The method of charging a vehicle according to claim 34 wherein:
the providing step further includes, providing a second rotor blade assembly;
the first rotor blade assembly comprising at least one axially balanced airfoil, the second rotor blade assembly comprising leading and trailing ends, defining respective leading and trailing openings, the leading end connected to the trailing end through a plurality of spaced blades;
the first rotor blade assembly comprising a chord length greater than a span of the airfoil, having trailing ends configured for clockwise rotation, the first rotor blade assembly disposed within the second rotor blade assembly;
wherein a wing tip of each airfoil of the first rotor blade assembly is bounded by an inside surface of the second rotor blade assembly;
wherein further an area of the leading opening of the second rotor blade assembly is larger than an area of the trailing opening of the second rotor blade assembly, thereby forming a conically shaped second rotor blade assembly; and
a first end of each blade connected to the leading end of the outer rotor blade assembly is radially offset from a second end of each blade connected to the trailing end of the second rotor blade assembly, thereby forming a spiral blade configuration on the second blade assembly.
